(19) United States
(12) Patent Application Publication
(10) Pub. No.: US 2002/0089619 A1
(43) Pub. Date: Jul. 11, 2002

(54) Backlight module for transflective liquid crystal display

(76) Inventors: Yuan-wen Liu, Hsin Chu (TW); Kuang-lung Tsai, Hsin Chu (TW); Chun-Hui Tsai, Hsin Chu (TW)

Correspondence Address: Birch, Stewart, Kolasch & Birch, LLP, P. O. Box 747, Falls Church, VA, 22040-0747, US

(21) Appl. No.: 09/754,360

(22) Filed: Jan. 5, 2001

(51) Int. Cl. G02F 1/1335

(52) U.S. Cl. 349/61

(57) ABSTRACT

A backlight module for transflective liquid crystal display includes an LCD panel and a Cold Cathode Flat Fluorescent Lamp (CCFFL) installed on the back side of the LCD panel. The CCFFL lamp can be electrified and illuminated itself, and the lamp's surface having high reflectivity is smooth, thereby, the illumination is high and uniform. Therefore, the backlight module for transflective liquid crystal display can make the most of ambient light source to attain the object of conserving power.

### FIELD OF THE INVENTION

The invention relates to a backlight module for transflective liquid crystal display, and in particular, relates to a backlight module for transflective liquid crystal display that utilizes Cold Cathode Flat Fluorescent Lamp (CCFFL) to make the most of ambient light so as to attain the object of conserving power.

### BACKGROUND OF THE INVENTION

In general, liquid crystal display (LCD) can be divided into three types—the “reflective type”, the “transmissive type”, and the “transflective type” according to the transmission mode. The reflective LCDs utilize ambient light to illuminate the display. This is achieved by combining a reflector with a rear polarizer. Therefore, the reflective LCDs can work in an outdoors or in a bright indoor environment to conserve power by using ambient light without turning the light on. This is the advantage of the reflector LCDs, but the reflective LCDs are unable to perform the display function under dim light condition and this is the disadvantage of the reflective LCDs. Secondly, transmissive LCDs have a transparent rear polarizer and do not reflect ambient light, thereby, require a backlight to be visible, and do not need a reflector. Thus the transmissive LCDs can work in low light conditions with backlight on continuously. Because of no reflector, the transmissive LCDs can't perform the display function by reflecting the ambient light and need to turn the light on continuously that result in power consumption. This is the disadvantage of the transmissive LCDs.

Furthermore, the transflective LCDs are a mixture of the reflective and transmissive type of LCDs. This kind of transflective LCDs can be used in association with the backlight under any kind of lighting conditions. The backlight can be left off where there is sufficient outside lighting for conserving power. While in relatively darker environments, the backlight is turned on to provide a bright display. Besides, the transflective LCDs will not “wash out” when operated in direct sunlight. Consequently, the transflective LCDs are able to combine both the advantages of the reflective and transmissive types of LCDs.

FIG. 1 is a schematic cross-sectional view of the transflective LCDs according to a prior art. As shown in FIG. 1, the backlight module for transflective LCDs of the prior art includes an edge light source 10, a light guide plate 20, and an LCD panel 30, wherein the light guide plate 20 further includes a diffuser 22 and a brightness enhancement film 24 provided thereon. The diffuser 22 is used to diffuse the light coming from the edge light source 10 located at a side of the light guide plate 20 to make the surface illumination of the LCD panel 30 uniform. Moreover, the brightness enhancement film 24 is used to improve the illumination per unit area of the LCD panel 30. The disadvantage of this kind of transflective LCDs is that the reflecting intensity of the backlight module is not satisfactory.

Besides, since the transflective LCDs being making use of the mode of “edge light and light guiding” cause non-uniformity in luminance, the light guide plate 20 needs to have a diffuser 22 and a brightness enhancement film 24 provided thereon, but this will deteriorate the reflecting efficiency. At present, one way to enhance the reflecting intensity is plating an aluminum film 26 on the bottom of the LCD panel, but this way will attenuate the luminance intensity while the bottom backlight 12 passing through the aluminum film 26. In other words, the reflecting light enhances while the transmission light attenuates. That is, an advantage will mostly come with a disadvantage and it is impossible to complete in both respects.

### SUMMARY OF THE INVENTION

In accordance with the disadvantages of the technology of the prior art, the invention provides a CCFFL for the transflective backlight module. The CCFFL's surface having high reflectivity is smooth. Moreover, the CCFFL can be electrified and illuminated itself, and the illumination is high and uniform. What is more, the CCFFL can make the most of ambient light source and needs no diffuser and light enhancement film so as to attain the object of conserving power and reducing cost.

Regarding the invention's object, advantages and characteristics as above-described or others can be better understood by the following “detailed description of the preferred embodiments”.

### BRIEF DESCRIPTION OF THE DRAWINGS

FIG. 1 is a schematic cross-sectional view of the transflective LCDs according to a prior art.

FIG. 2 is a schematic cross-sectional view of transflective LCDs in accordance with the invention.

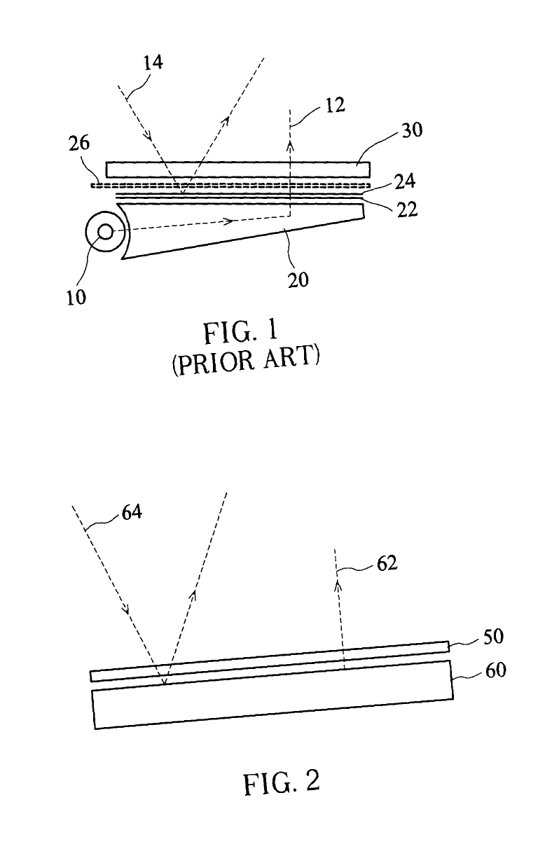

### DETAIL DESCRIPTION OF THE PREFERRED EMBODIMENTS

FIG. 2 is a cross-sectional view of the transflective LCD in accordance with the invention. As shown in FIG. 2, the backlight module for the transfiective LCD in accordance with the invention includes an LCD panel 50 and a CCFFL 60, wherein the CCFFL 50's lamp surface has high reflectivity. The lamp can be electrified and illuminated itself, also the illumination is high and uniform. The transflective LCD is used in association with a backlight 62 under any kind of lighting conditions. Moreover, the CCFFL can be left off for saving power while the ambient light 64 is sufficient. In the dark environments, the CCFFL 60 can be turned on to provide a bright display. Besides, the transflective LCD will not “wash out” when operated in direct sunlight. So the transflective LCD can make the most of the ambient light source and needs no diffuser and “brightness enhancement film” in order to attain the object of conserving power and reducing cost.

If the transflective LCDs are often used in an environment with sufficient brightness, then, enhancing the reflecting intensity becomes necessary, and a metallic film of 50˜1,000 Å in thickness, and being made of aluminum or chromium can be provided between the LCD panel 50 and CCFFL 60. A diffuser and/or a brightness enhancement film can also be added in the backlight module.

While the invention has been described by way of example and in terms of a preferred embodiment, it is to be understood that the invention is not limited to the disclosed embodiment. On the contrary, it is intended to cover various modifications. Therefore, the scope of the appended claims should be accorded the broadest interpretation so as to encompass all such modifications.

What is claimed is:

1. A backlight module for transflective liquid crystal display (LCD) comprising;
an LCD panel; and
a cold cathode flat fluorescent lamp (CCFFL) installed on the back side of the liquid crystal display panel.

2. The backlight module for transflective liquid crystal display (LCD) of claim 1, wherein a metallic film of 50˜1,000 Å thickness is provided in between said LCD panel and said CCFFL.

3. The backlight module for transflective liquid crystal display (LCD) of claim 2, wherein said metallic film provided in between said LCD panel and said CCFFL is made of aluminum.

4. The backlight module for transflective liquid crystal display (LCD) of claim 2, wherein said metallic film provided in between said LCD panel and said CCFFL is made of chromium.

5. The backlight module for transflective liquid crystal display (LCD) of claim 1 further comprising a diffuser.

6. The backlight module for transflective liquid crystal display (LCD) of claim further comprising a brightness enhancement film (BEF).

7. The backlight module for transflective liquid crystal display (LCD) of claim 1 further comprising a diffuser and brightness enhancement film (BEF).
